(19) United States
(12) Patent Application Publication
(10) Pub. No.: US 2013/0041536 A1
(43) Pub. Date: Feb. 14, 2013

(54) WHEEL DRIVE ARCHITECTURE FOR ELECTRIC VEHICLES

(71) Applicants: Kevin John Power, Novi, MI (US); Kevin Fisher, Novi, MI (US); Anthony Jones, Novi, MI (US)

(72) Inventors: Kevin John Power, Novi, MI (US); Kevin Fisher, Novi, MI (US); Anthony Jones, Novi, MI (US)

(73) Assignee: Tata Technologies Pte. Ltd., Singapore (SG)

(21) Appl. No.: 13/561,438

(22) Filed: Jul. 30, 2012

(30) Foreign Application Priority Data
Aug. 8, 2011 (IN) 2230/MUM/2011

(51) Int. Cl. B60L 15/20

(52) U.S. Cl. 701/22

(57) ABSTRACT

A drive train assembly adapted to control running state performance of at least two wheels of an electrical vehicle wherein the drive train assembly is adapted for the electrical vehicle comprises of two wheel drive or four wheel drive. The said assembly is adapted for working in a driving economy and a normal mode via an embedded controller device.

This application claims benefit of Serial No. 2230/MUM/2011, filed 8 Aug. 2011 in India and which application is incorporated herein by reference. To the extent appropriate, a claim of priority is made to the above disclosed application.

### FIELD OF THE INVENTION

The present invention relates to a wheel drive train assembly adapted to control and optimize running state performance of at least two wheels of an electrical vehicle. The invention can be extended to four wheels. Specifically the invention relates to an electric vehicle that has a drive means electrically connected with each motor for driving each wheel independently butin a coordinated manner.

### BACKGROUND OF THE INVENTION

Conventional vehicles drive the wheels through power derived from a single discrete source, i.e. engine. The power is transferred to the wheels via a transmission and gear mechanism to achieve rotation of wheels. Manufacturers generally employ two wheel drive or four wheel drive for driving the vehicle.

In a condition wherein the vehicle is driven in straight line, all wheels of vehicle are rotating at the same speed and can be driven easily from a single source. However, while turning the vehicle or in conditions of wheel slip, the corresponding wheels are required to rotate at different speeds even though they all are deriving their motion from a single source. To mitigate this problem generally mechanical gear and differential coupling assemblies are employed that allow wheels to rotate at different speeds.

These mechanical assemblies have limitations which result in the following problems:
a) Limitations in wheel speed synchronization during hard cornering conditions.
b) Inability to easily recover from complete loss of traction of one wheel.
c) Lack of uniform tractioning in all weather conditions.
d) Dependent on steering geometry and weight distribution of the vehicle, the appearance of under steer or over steer.

The two wheel drive architecture is available with front wheel drive and rear wheel drive variants. Both of these variants suffer from the aforesaid general problems.

In case of four wheel drive architecture, all four wheels or at least pair thereof is expected to be driven independently. The four wheel drive gives significant benefits such as superior traction in all weather conditions, superior driving experience for driver e.t.c. Four wheel drives is implemented by a precise traction control inter-engaged with various mechanical means which are in addition to any mechanical devices already in place to achieve two wheel drives. These devices add inefficiencies and weight to the vehicle. Also, because of the nature of the mechanical mechanisms, a wide range of control is impossible.

Thus there exists a need to address the long standing problem of achieving four wheel or two wheel drive architecture having less mechanical complexity, less weight and by extension less cost. The wheel drive system should also have a wider range of control which will enable superior tractions in all weather conditions and increased safety at the limits of handling.

As discussed earlier, conventional internal combustion engine drive systems are based on a single source and mechanical solutions. These have shortcomings and range of capability which can be overcome by the proposed invention.

### OBJECTS OF THE INVENTION

The principal object of the invention is to provide alternate drive train architecture for driving an electric vehicle enabling drivability, handling, safety and range.

Another object of the invention is to provide two modes of driving viz. economy and normal driving controlled by an embedded controller device thereby adjusting a combination of motor speed, power and ancillary consumption, the second mode will extend the range in the electric vehicle.

A further object of the invention is to provide indication to the driver of signal intent regarding speed, brakes, and indication of direction via a sensor means built into the electric vehicle.

Still another object of the invention is to provide a feedback and enhance control capabilities to driver for a devising a wide variety of multi wheel drive systems and responses.

### SUMMARY OF THE INVENTION

Before the assembly, components and methods are described, it is to be understood that this invention is not limited to the particular assembly and methods described, as there can be multiple possible embodiments of the present invention, which are not expressly defined in the present disclosure. It is also to be understood that the terminology used in the description is for the purpose of describing the particular versions or embodiments only, and is not intended to limit the scope of the present invention which will be limited only by the appended claims.

In one aspect of the invention, a drive train assembly is provided to control and optimize running state performance of at least two wheels of an electric vehicle, comprising at least two front steerable wheels and at least two rear non-steered wheel, each wheel individually coupled with a motor; a drive means electrically coupled with each motor for driving the coupled wheel independent of other wheel of said electric vehicle; and an embedded controller device and a memory having executable instructions to control and coordinate varying frequency of inverters attached to vehicle wheel motors based on driver inputs including steering angle, acceleration, brake force, and feedback value as input parameters from each wheel thereby selectively controlling speed of wheels resulting in coordinated driving performance of the vehicle.

In another aspect of the invention, a method is provided to control and optimize running state performance of at least two wheels of an electric vehicle via an embedded controller device adapted to control state values including rotational speed value, steering angle, and brake force of the vehicle, the method comprising; sensing a first state value of the vehicle; receiving a request for second state values of the vehicle from vehicle driver; altering the first state values of the vehicle to the second state values by controlling the driver input to the corresponding wheel; calculating running state coordination ratio of at least two wheels; and controlling the operation of drive means, and motors in accordance with running state coordination ratio of at least two wheels of the electric vehicle.

In another aspect of the invention, an assembly is provided for wheel drive architecture comprising a motor coupled with each wheel respectively and control via a Vehicle Control Unit (VCU) to coordinate the wheels respectively. The VCU receives input from sensors that indicate driver intent viz acceleration and braking and using software algorithms, produces signals that control each motor. This mechanism ensures that the motors follow accurately driver intent where this is appropriate.

In another aspect of the invention, a drive train assembly is provided for enabling driver two modes of driving i.e. economy and normal drive.

In an another aspect of the invention, a drive train assembly is provided for driving two or four wheels in coordinated manner such that superior control can be achieved over individual wheel rotational speed.

### BRIEF DESCRIPTION OF DRAWINGS

The foregoing summary, as well as the following detailed description of preferred embodiments, is better understood when read in conjunction with the appended drawings. For the purpose of illustrating the invention, there is shown in the drawings example constructions of the invention; however, the invention is not limited to the specific assembly and methods disclosed in the drawings: The present invention will now be described with reference to the accompanying drawing, in which:

FIG. 1 illustrates a modeling architecture for a two wheel drive multi motor solution according to various exemplary embodiments of the invention.

FIG. 2 illustrates a functioning of vehicle control unit (VCU) according to exemplary embodiments of the invention.

FIG. 3 illustrates example with regards to a steering angle algorithm during turn problem according to one exemplary embodiment of the invention.

FIG. 4 illustrates the architecture for a four wheel drive multi motor solution according to various exemplary embodiments of the invention.

FIG. 5(a,b,c,d) illustrates architecture of the embedded software according to exemplary embodiment of the invention.

### DETAILED DESCRIPTION OF THE INVENTION

Some embodiments of this invention, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any assemblies and methods similar or equivalent to those described herein can be used in the practice or testing of embodiments of the present invention, the preferred, systems, assemblies and methods are now described. The disclosed embodiments are merely exemplary of the invention, which may be embodied in various forms.

A drive train assembly adapted to control and optimize running state performance of at least two wheels of an electric vehicle, comprising: at least two front steerable wheels and at least two rear non-steered wheel, each wheel individually coupled with a motor; a drive means electrically coupled with each motor for driving the coupled wheel independent of other wheel of said electric vehicle; and an embedded controller device and a memory having executable instructions to control and coordinate varying frequency of inverters attached to vehicle wheel motors based on driver inputs including steering angle, acceleration, brake force, and feedback value as input parameters from each wheel thereby selectively controlling speed of wheels resulting in coordinated driving performance of the vehicle.

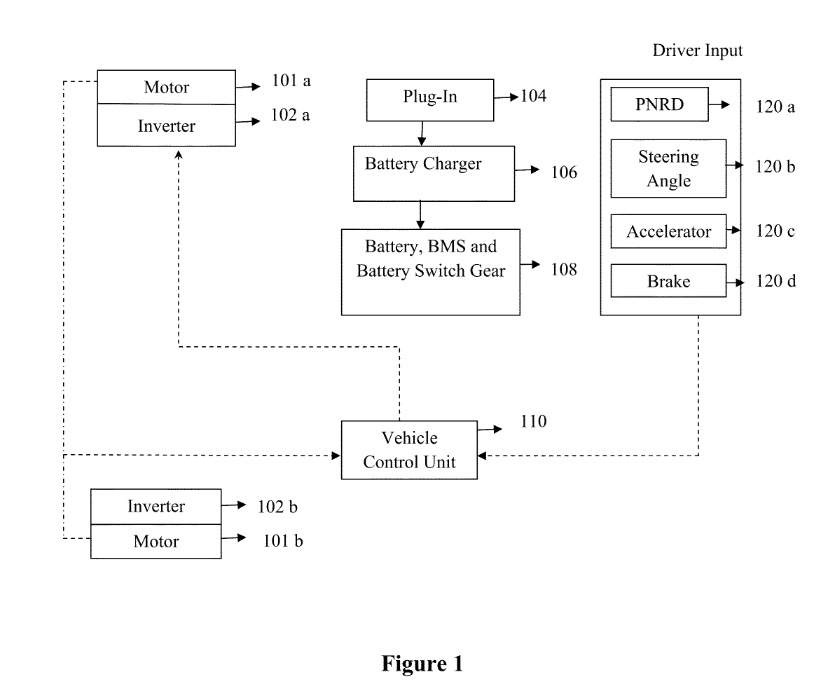

FIG. 1 illustrates a modeling architecture for a two wheel drive multi motor solution for an electric vehicle.

Referring to FIG. 1, a drive train assembly 100 comprises of a drive means electrically connected with at least one motor for driving at least one wheel independently. According to preferred embodiment of the invention a drive train assembly 100 comprises a two motor 101a and 101b coupled with the two wheels. The inverters 102a and 102b coupled to the motor 101a and 102b via a three phase alternating current (AC) bus. The inverter 102 a and 102b convert DC power from the battery into three phase electricity of varying frequency allowing for speed control of the motor 101a and 101b.

According to another embodiment of the invention a drive train assembly 100, further comprises of a driver input 120. The driver inputs comprises of a means for calculating a rotational speed value for inter-wheel coordination associated with driver inputs and current instantaneous wheel rotational speeds; a means for calculating a wheel acceleration of each of the wheel; a means for determining a steer angle associated with a steering input from the driver; a means for determining the brake force required by the driver; a means for determining and controlling an input frequency to each drive of the motor; and a means for initiating a limp mode for enabling to reduce the power consumption.

According to preferred embodiment of the invention the driver input comprises a group of sensors for sensing the various driver input. According to exemplary embodiment of the invention the sensors used are a steering angle sensor 120b provides indication of direction; an accelerator sensor 120c adapted to give an indication to desire speed; a brake pedal sensor 120d adapted to give an indication of driver intention to slow down or stop.

According to another embodiment of the invention a drive train assembly 100, further comprising Park, Neutral, Reverse, Drive (PNRD) means adapted to provide indication to park, engage forward direction or reverse direction, the PRND means comprises of sensor. Park, Neutral, Reverse, Drive refers to the control lever commonly used with automatic transmissions.

According to another embodiment of the invention a drive train assembly 100, further comprises an embedded controller device. In a preferred embodiment the embedded controller device is a Vehicle Control Unit (VCU) 110. The Vehicle Control Unit (VCU) 110 is embedded with software code that allows control of the motors 101a and 101b.

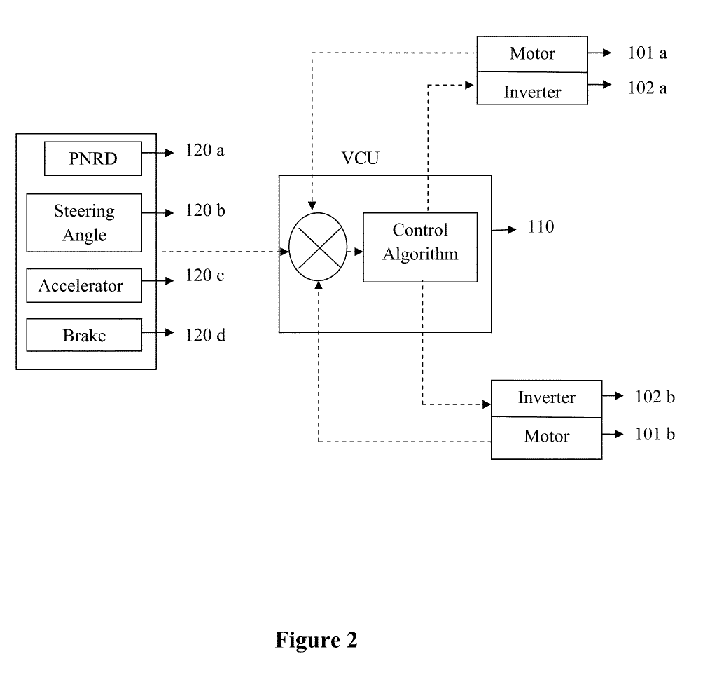

The Vehicle Control Unit (VCU) 110 receives inputs from driver and feedback from the wheel indicating the speed of individual wheels via accelerator sensors 120c disclosed above. This feedback and control capability can be used to provide a wide variety of multi wheel drive features (as shown in FIG. 2).

According to another embodiment of the invention the response time for the embedded controller device is less than 10 milliseconds upon receiving the inputs from a driver.

According to another embodiment of the invention a drive train assembly 100, further comprises plug-in 104, battery charger 106, and combination of battery, BMS and battery switchgear to operate the inverters 102a and 102b for providing power to motor 101a and 101b coupled with the wheels.

### Example 1

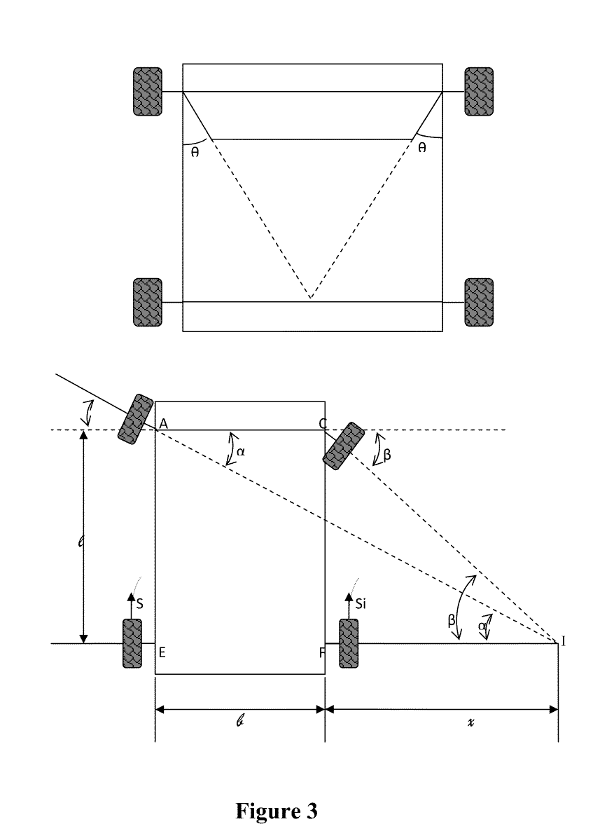

FIG. 3 illustrates example with regards to a steering angle algorithm during turn problem according to one exemplary embodiment of the invention. Referring to FIG. 3, consider for two drive means and assume that the vehicle is moving in the right direction. Let the speed of the inner wheel be Si as indicated in the FIG. 3. It is this speed at which the vehicle is turning. The outer wheels have to cover more distance as compared to the inner wheels and hence the outer wheels need to rotate faster.

Let the speed of the outer wheels be Sₒ. To complete the full circle, time taken by the inner wheels is ‘Ti’ which is same as that of the outer wheels say ‘To’.

Tan α=1/(b+x) (1)

Tan β=1/x

(For inner wheels)

Tᵢ=2π×/Sᵢ

(For outer wheels)

To=2π(b+x)/Sₒ

∴Sₒ=(b+x/x)Sᵢ (2)

From equations 1 and 2,

Sₒ=[1/tan α/1/tan α−b]Sᵢ

Sₒ=[1/1−b tan β]Sᵢ

Final governing equation for Outer and Inner wheel speed

Where,

1—Wheel base
b—Track width

The required steering angle can be read from driver input.

The above equation relates to the case of adjusting wheel speed strictly to take into account a turning radius. The equation can be modified as follows:

Sₒ=[1/1−b tan α]Sᵢ+K

Variation of the constant K can result in certain additional features offered by the two wheel architecture. These are listed as below:

1. If K is set to some positive value, then so will be slightly increased and the turning radius will be increased. This effect is limited by tire scrub but will help with driver effort, turning radius and vehicle feel.

2. In the case of under steer, K can be set to a positive value to compensate for this behavior

3. In the case of over steer, K can be set to a negative value to compensate for this behavior.

As mentioned previously, electric vehicles are limited in range by available energy in the battery. Any strategy that reduces energy drain on the battery will result in increased range. As an approach to transferring this effect into a choice for the driver, it is possible to present two or modes of operation. For example, assuming there are two modes: normal and economy. Normal would not restrict any functions in the vehicle. However, economy could affect some vehicle functions as listed below:

1. Reduce power available to the drive train so that performance is reduced

2. Disable certain functions such as power windows, power steering

3. Reduce or eliminate cabin heating or cooling

4. Disable lighting functions that are not required by regulation.

With four wheel drive architecture, it is possible to drive only two wheels at a time while disabling two motors. This would reduce power consumption from the battery and allows the possibility of a “limp mode”. At times when battery energy is almost finished, application of two wheels only drive would allow for an extended range.

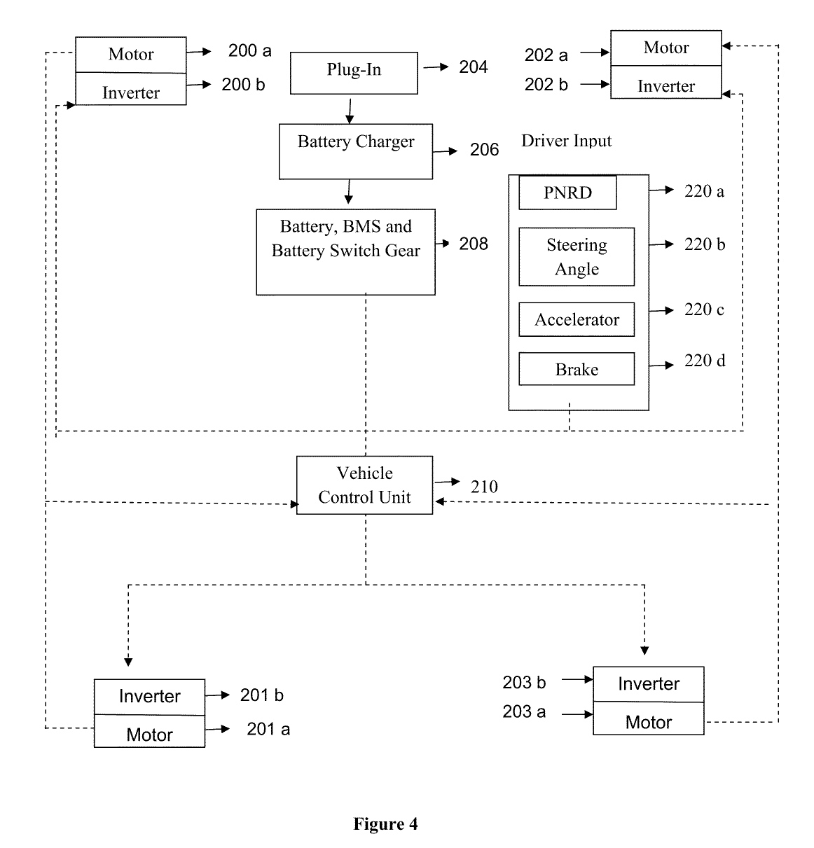

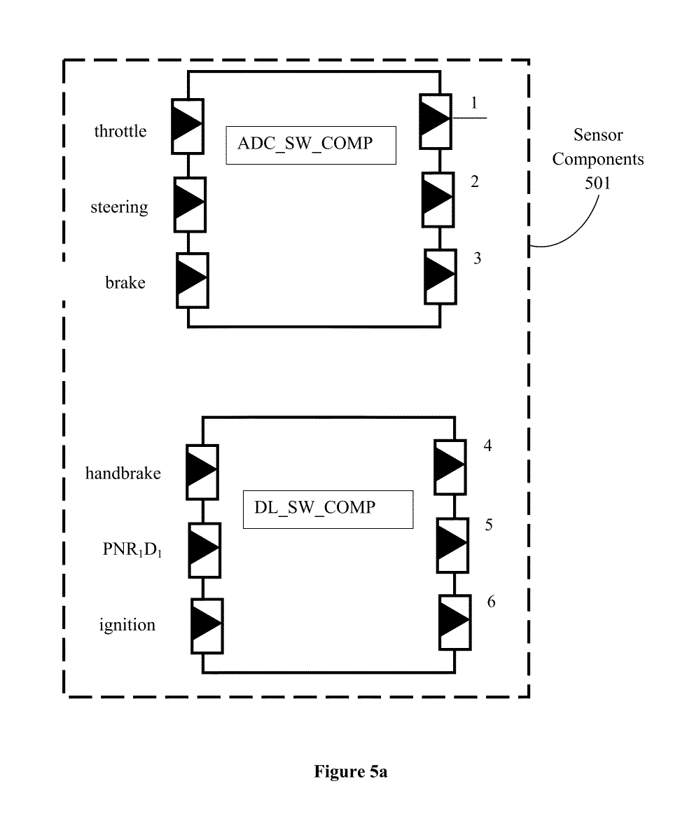

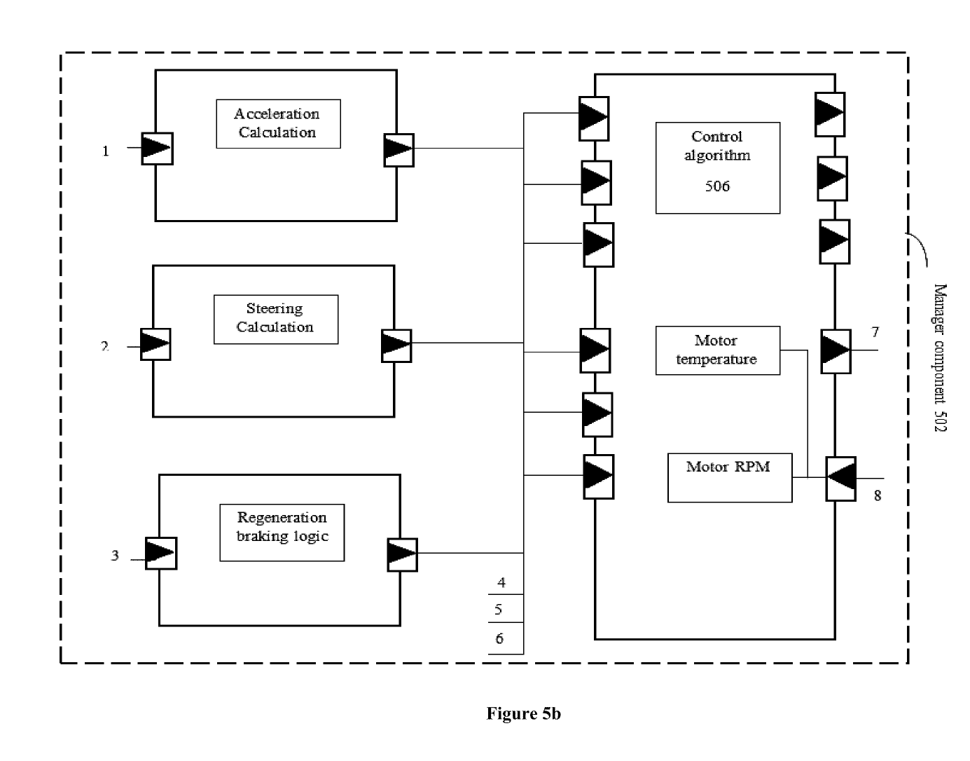

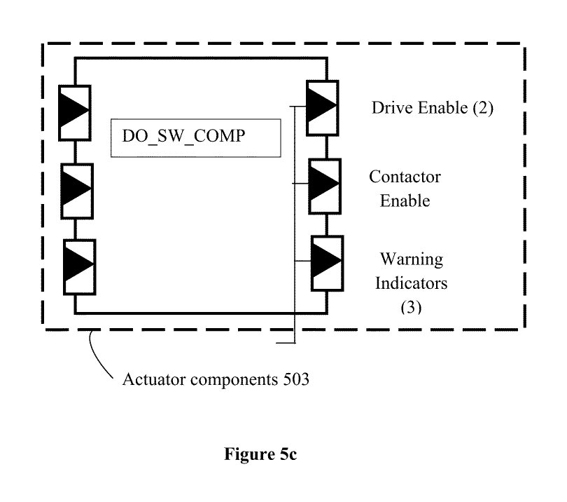

FIG. 4 illustrates the architecture for a four wheel drive multi motor solution for an electric vehicle according to various exemplary embodiments of the invention. A four wheel drive assembly 200 comprises of a drive means electrically connected with all motors for driving all wheels independently. According to preferred embodiment of the invention, the assembly 200 comprises of four motors 201a, 201b, 201c, and 201d coupled to all four wheels respectively. The drive train assembly 200 further comprises four inverters 202a, 202b, 202c and 202d connected to the motor via a three phase alternating current (AC) bus. The inverters convert DC power into three phase electricity of varying frequency allowing for speed control of the four motors.

According to one embodiment of the invention the drive train assembly 200, further comprises the elements to provide indication of driver intent 220. The driver inputs comprises of a means for calculating a rotational speed value for inter-wheel coordination associated with driver inputs and current instantaneous wheel rotational speeds; a means for calculating a wheel acceleration of each of the wheel; a means for determining a steer angle associated with a steering input from the driver; a means for determining and controlling an input frequency to each drive of the motor; and a means for initiating a limp mode for enabling to reduce the power consumption.

According to preferred embodiment of the invention the driver input comprises a group of sensors for sensing the various driver input. According to exemplary embodiment of the invention the sensors used are a steering angle sensor 220b provides indication of direction; an accelerator sensor 220c adapted to give an indication to desire speed; a brake pedal sensor 220d adapted to give an indication of driver intention to slow down or stop.

According to another embodiment of the invention the drive train assembly 200, further comprising Park, Neutral, Reverse, Drive (PNRD) means 220a adapted to provide indication to park, engage forward direction or reverse direction, the PRND means comprises of sensor. Park, Neutral, Reverse, Drive means refers to the control lever commonly used with automatic transmissions.

According to another embodiment of the invention the drive train assembly 200, further comprises an embedded controller device. In a preferred embodiment the embedded controller device is a Vehicle Control Unit (VCU) 210. The Vehicle Control Unit (VCU) 210 is embedded with software code that allows control of the motors 201a, 201b, 201c and 201d. The Vehicle Control Unit (VCU) 210 receives inputs from driver and feedback from the wheel indicating the speed of individual wheels via accelerator sensors 120c disclosed above.

The assembly 200 comprises a vehicle control unit 210 embedded with software code that allows control of the motors. The Vehicle Control Unit (VCU) 210 receives inputs from driver and feedback from the wheel indicating the speed of individual wheels via accelerator sensors 220c disclosed above.

The drive train assembly 200 further comprises plug-in 204, battery charger 206, and combination of battery, BMS and battery switchgear to charge the inverters for providing power to motor coupled with the wheels.

### Example 2

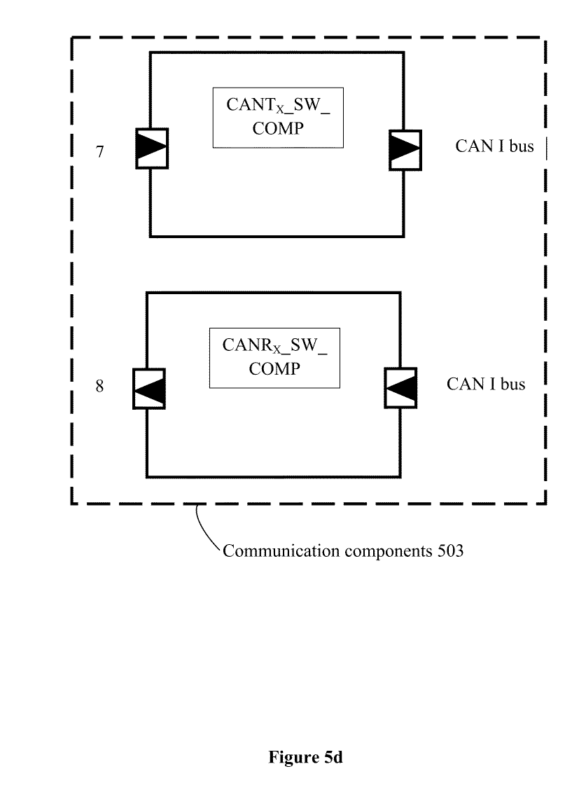

FIG. 5(a,b,c,d) illustrates architecture of the embedded software according to exemplary embodiment of the invention. Architecture of the embedded software comprises of Sensor Components 501, Manager Components 502, Actuator Components 503, Communication Components 504 and Control Algorithm 506.

According to an embodiment the sensor component 501 enables a measurable response to a physical condition like indication of direction, indication to desire speed, an indication of driver intention. Software components will read the physical sensor inputs and update the storage variables periodically. The sensor component 501 may comprises a steering angle sensor to provide indication of direction, an accelerator sensor adapted to give an indication to desire speed, a brake pedal sensor adapted to give an indication of driver intention to slow down or stop and Park, Neutral, Reverse, Drive (PNRD) means adapted to provide indication to park, engage forward direction or reverse direction.

According to an embodiment, the manager components 502 based on sensor component inputs, the algorithm and control logic will drive the actuator and communication components. The manager components 502 further comprises control algorithm 506 wherein the control logic will be developed with addressing the essential safety requirements. The manager components 502 will calculate the acceleration, steering angle, and regeneration braking logic via an inputs receive from sensor components 501.

According to an embodiment, the actuator components 503 enables for moving or controlling a mechanism or assembly. Software components will drive the physical actuators such as motor drives (inverter/s for motor control), contactors etc. as applicable.

According to an embodiment, communication components 504 enables for communication activity for sending and receiving messages. The software components will transmit and receive messages via CAN bus to/from Motor drives and communication with ABS ECU only for monitoring wheel speed in case it is not monitored through stand-alone sensors. The provision to connect to any other ECUs as ancillary systems such as Battery Management System, Infotainment System, and HVAC system will be over CAN bus.

### ADVANTAGES OF THE INVENTION

The technical advancements of the present invention include:
1) Provide a superior traction to a vehicle in all weather condition;
2) Provide an increased safety condition where an automobile is pushed to limits of its handling capacity;
3) Provide a superior driving experience for driver of a vehicle;
4) Provide an ability to correct under steer and over steer conditions;
5) Provide less mechanical complexity in the assembly; and
6) Provide dynamic changes in control strategies to suit driving condition.
7) Allow a driver to choose between driving modes to allow for range extension at the expense of performance
8) Provide a means for a limp mode in the four wheel drive configuration

1. A drive train assembly adapted to control and optimize running state performance of at least two wheels of an electric vehicle, comprising:
at least two front steerable wheels and at least two rear non-steered wheel, each wheel individually coupled with a motor;
a drive means electrically coupled with each motor for driving the coupled wheel independent of other wheel of said electric vehicle; and
an embedded controller device and a memory having executable instructions to control and coordinate varying frequency of inverters attached to vehicle wheel motors based on driver inputs including steering angle, acceleration, brake force, and feedback value as input parameters from each wheel thereby selectively controlling speed of wheels resulting in coordinated driving performance of the vehicle.

2. A drive train assembly as defined in claim 1, wherein the electrical vehicle configured for two wheel drive or four wheel drive.

3. A drive train assembly as defined in claim 1, further comprising a means for initiating a limp mode for enabling to reduce the power consumption.

4. A drive train assembly as defined in claim 1, further comprising Park, Neutral, Reverse, Drive (PNRD) means adapted to provide indication to park, engages forward direction or reverse direction, the PRND means comprises of sensor.

5. A drive train assembly as defined in claim 4, wherein the PRND means can include two modes of drive comprises of sport and economy mode.

6. A drive train assembly as defined in claim 1, wherein the steer angle is determined by steering angle sensors connected with two or four wheels coupled with controller to provide signals for enabling wheels displacement in coordinated manner respectively.

7. A drive train assembly as defined in claim 1, wherein the inverters convert direct current power into three phase electricity of varying frequency for enabling the speed control of vehicle.

8. A drive train assembly as defined in claim 1, wherein a response time of the embedded controller device is less than 10 milliseconds upon receiving the inputs from a driver.

9. A method adapted to control and optimize running state performance of at least two wheels of an electric vehicle via an embedded controller device adapted to control state values including rotational speed value, steering angle, and brake force of the vehicle, the method comprising;
sensing a first state value of the vehicle;
receiving a request for second state values of the vehicle from vehicle driver;
altering the first state values of the vehicle to the second state values by controlling the driver input to the corresponding wheel;
calculating running state coordination ratio of at least two wheels; and
controlling the operation of drive means, and motors in accordance with running state coordination ratio of at least two wheels of the electric vehicle.

10. A method as defined in claim 9, further comprising initiating a limp mode for enabling to reduce the power consumption.

11. A method as defined in claim 9, wherein the electrical vehicle configured for two wheel drive or four wheel drive.
